(19) United States
(12) Patent Application Publication
(10) Pub. No.: US 2015/0218875 A1
(43) Pub. Date: Aug. 6, 2015

(54) INTERMEDIATE ATTACHMENT MEMBERS FOR SECURING ACCESSORIES TO INTERIOR SURFACES OF SAFES, SAFE STORAGE SYSTEMS AND METHODS FOR STORING ITEMS IN SAFES

(71) Applicant: Universal Interiors, LLC, Orem, UT (US)

(72) Inventors: Christie Richards, Orem, UT (US); Jacob Richards, Orem, UT (US)

(21) Appl. No.: 14/614,218

(22) Filed: Feb. 4, 2015

Related U.S. Application Data
(60) Provisional application No. 61/935,721, filed on Feb. 4, 2014.

(51) Int. Cl. E05G 1/02; A44B 18/00; F16M 13/02

(52) U.S. Cl. CPC E05G 1/02; F16M 13/022; A44B 18/00

(57) ABSTRACT

An intermediate attachment member may be configured to enable accessories for a safe (e.g., a gun safe, etc.) or another container (e.g., a cabinet, a locker, etc.) to be secured to an interior surface of a safe (e.g., inside a door of the safe, to a wall of the safe, etc.) or other container that lacks features (e.g., a loop material, etc.) the accessory is configured to engage. The intermediate attachment member may include a substantially flat body with a rear surface that carries a coupling element that will engage a feature of the interior surface of the safe or other container (e.g., a clip that will engage a loop on the interior surface, etc.) and a front surface that carries an engagement material (e.g., a loop material, etc.) that will mutually engage a complementary engagement material (e.g., a hook material, etc.) of the accessory. Systems for and methods that enable the storage of items on interior surfaces of safes and other containers are also disclosed.

### CROSS REFERENCE TO RELATED APPLICATION

A claim for the benefit of priority to the Feb. 4, 2014 filing date of U.S. Provisional Patent Application No. 61/935,721, titled INTERMEDIATE ATTACHMENT MEMBERS FOR SECURING ACCESSORIES TO INTERIOR SURFACES OF SAFES, SAFE STORAGE SYSTEMS AND METHODS FOR STORING ITEMS IN SAFES (“the '721 Provisional Application”) is hereby made pursuant to 35 U.S.C. §119(e). The entire disclosure of the '721 Provisional Application is hereby incorporated herein

### TECHNICAL FIELD

This disclosure relates generally to devices, referred to herein as “intermediate attachment members” or, more simply, as “attachment members,” that enable accessories to be secured to interior surfaces of safes and other containers (e.g., cabinets, lockers, etc.). More specifically, this disclosure relates to intermediate attachment members that enable the attachment of accessories to a surface to which the accessories could not otherwise be secured. In particular, this disclosure includes intermediate attachment members that are configured to engage loops, pockets or other features on an interior surface of a safe or another container, as well as to mutually engage attachment features of existing accessories for safes and other containers.

### RELATED ART

Safes are often used to store valuable items. Many safes include features that are specifically configured to enable them to store and secure guns, or firearms. Various features have been designed for this purpose, including a number of features that enable guns, accessories and other items to be carried by the interior of the door of a safe.

Among the various accessories that have been made for safes are door panels that include a number of features (e.g., pockets, loops, etc.) that receive and organize guns and other items, and hold them in place relative to the interior surface of the safe door. The features of many safe door panels are fixed, limiting the types and numbers of items that may be held by such a door panel, as well as the manner in which the items may be arranged over the door panel.

Greater flexibility, including the ability to customize the arrangement of guns and/or other items on a surface, has been provided by way of smaller accessories. Many of the currently available accessories for securing guns and other items to the interior surfaces of safes include a so-called “hook material,” which engages a complementary “loop material,” such as the hook and loop materials available as VELCRO® fasteners. While a hook material may secure an accessory to a safe that has been lined with a loop material, such as the type of material frequently used to line the trunks of automobiles, these materials are generally only used in less expensive safes; many currently available accessories cannot engage the interior surfaces of high-end safes.

### SUMMARY

An intermediate attachment member is configured to enable an accessory to be secured to a surface, such as an interior surface of the door of a safe or another container (e.g., a cabinet, a locker, etc.) or to another interior surface within the safe or other container. The intermediate attachment member may be configured for use with an accessory that, without the intermediate attachment member, could not otherwise be secured to the surface.

In a specific embodiment, an intermediate attachment member may be thin, or have a low profile, which may minimize the distance the intermediate attachment member protrudes from a surface to which it is secured. Such an intermediate attachment member may include a substantially flat body with a rear surface and a front surface.

The rear surface of the substantially flat body may be configured to face, or be positioned against, the interior surface, and may carry a coupling element. The coupling element may be configured to engage a feature at a surface to which the intermediate attachment member is to be secured. In a specific embodiment, the coupling element may comprise a clip or any other suitable feature that will engage a loop, pocket or other feature of a door panel (e.g., an element permanently secured over the interior of the safe door to enable items to be organized and secured in place over and carried by the interior surface of the safe door, etc.) or door cover (e.g., an element configured to be removably positioned over the interior surface of the safe door to enable organized and secured in place over and carried by the interior surface of the safe door, etc.) for a safe or another container.

The front surface of the substantially flat body of the intermediate attachment member may be configured to engage an accessory (e.g., a pistol holder, a pouch, a basket, etc.), and to hold the accessory in place relative to a surface to which the intermediate attachment member is secured. Thus, the front surface of the substantially flat body may carry an engagement element that engages or is engaged by a complementary engagement element of the accessory. The engagement element may be substantially flat, which may enable minimization of the distance the intermediate attachment member and the accessory protrude from a surface over which they are secured.

A storage system for a safe or another container may include an intermediate attachment member, a feature on a surface to which the intermediate attachment member may be secured, and an accessory. A plurality of intermediate attachment members may be used in a storage system. When a plurality of attachment members are used, a combination of two or more attachment members may be used in combination to secure an accessory to an interior of the safe or other container and/or one or more accessories may be secured to the interior of the safe or other container by a corresponding, single attachment member of the plurality. A storage system may include a safe (e.g., a gun safe, etc.) with a plurality of attachment members secured in place on or over an interior of a door of the safe. One or more of the attachment members may each secure a corresponding single item (e.g., a pistol case; a loop for thin, elongated items; a strap for larger items, etc.) in place on or over the interior of the door. Two or more additional attachment members may be positioned laterally adjacent to one another over the interior surface of the door to collectively hold a pouch or another larger item in place on or over the interior surface of the door.

Attachment members that incorporate teachings of this disclosure may enable customization of the manner in which accessories are arranged over interior surfaces within a safe or another container, even in situations where door panels or similar accessories are not configured for such customization. As a non-limiting example, one or more attachment members according to this disclosure may be used with a non-customizable element (e.g., a door panel, a door cover, etc.) that includes a number of fixed features (e.g., one or more loops, one or more straps for receiving and securing the barrels of rifles or shotguns, one or more pockets, etc.). The coupling element of an attachment member may be secured to a selected one of the fixed features to enable another accessory to be held in place over the previously non-customizable element and, thus, to enable an individual to use the non-customizable element to customize an arrangement of accessories and items within the interior of the safe or other container.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 is a perspective view of an embodiment of an attachment member;

FIG. 2 is a front view of the embodiment of attachment member shown in FIG. 1;

FIG. 3 is a rear view of the embodiment of attachment member shown in FIG. 1;

FIG. 4 is a side view of the embodiment of attachment member shown in FIG. 1;

FIG. 5 depicts an embodiment of a manner in which a coupling element of an attachment member may be secured in place over a surface;

FIGS. 6 and 7 illustrate embodiments of the manner in which an attachment member may secure an accessory in place over a surface;

FIG. 8 shows an embodiment of an arrangement of attachment members over a surface; and

FIG. 9 shows an embodiment of an arrangement of accessories over the surface.

### DETAILED DESCRIPTION

As illustrated by FIG. 8, an interior surface of a door or another interior surface of a safe (e.g., a gun safe, etc.) may be lined with a panel 10 that is configured to enable one or more items to be secured to the panel 10 and, thus, to be held in place over the interior surface. Often, such a panel 10 includes two or more elongated strips 12 that are oriented horizontally and secured to the panel 10 at a plurality of spaced apart, or intermittent, locations 14a, 14b, etc. The result of this arrangement is a strip 12 that provides a number of loops 16. The loops 16 may be configured to receive relatively small items, such as the barrel of a rifle or shotgun, in a manner that enables these items to be held in place on or over the panel 10 and, thus, on or over an interior surface of the safe. Unfortunately, the number of items that can be held in place by a relatively small, horizontally oriented loop is limited.

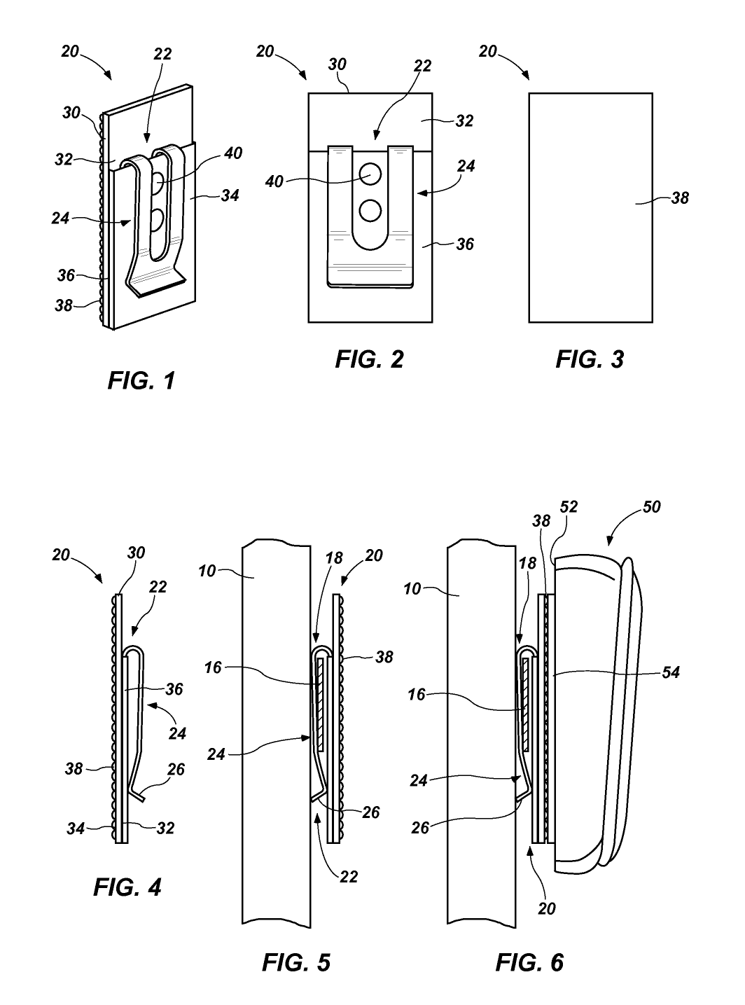

Turning now to FIGS. 1 through 7, an embodiment of an attachment member 20 is depicted. The attachment member 20 is configured to be positioned on or over an existing panel 10 (FIGS. 5-7) on an interior surface of a safe in a manner that expands the functionality of the panel 10 and enables a wider variety of different types of items to be secured to the panel 10 and, thus, held in place over the interior surface of the safe.

In the embodiment illustrated by FIGS. 1 through 4, the attachment member 20 includes a coupling element, shown as comprising a clip 22, that is configured to engage (or to be engaged by) a loop 16 (FIGS. 5-7), pocket or other feature on a panel 10 (FIGS. 5-7) that has been installed over an interior surface of a safe. In embodiments where the coupling element comprises a clip 22, an end 26 of an exterior portion 24 of the clip 22 (i.e., the portion of the clip that can be seen while viewing the attachment member 20) may flare away from a remainder of the attachment member 20, which may enable the exterior portion 24 of the clip 22 to be readily positioned within an opening 18 (FIGS. 5-7) defined by a loop 16 and to readily engage the loop 16. The clip 22 may have a width that enables it to be received by the loop 16. A length and a shape of the clip 22 may enable it to engage the loop 16 in a manner that will hold the attachment member 20 firmly and stably against the panel 10. A bent top 28 of the clip 22 may be configured to rest upon a top edge of the loop 16.

The clip 22 may be formed from any material that will withstand the weight, or at least a portion of the weight, of the item or items to be carried thereby. The clip 22 may be resilient, which may facilitate its engagement of a loop 16, as well as its removal from the loop 16 and subsequent re-use. In some embodiments, the clip 22 may comprise spring steel, a fiber-reinforced composite material or another material with similar properties.

An interior portion (not shown) of the clip 22, which is on an opposite side of the bent top 28 from the exterior portion 24, may be held in place by other parts of the attachment member 20. In the illustrated embodiment, the attachment member 20 includes a base 30 and a clip-securing piece 36. The clip-securing piece 36 is secured to a back side 32 of the base 30. The base 30 may have dimensions (e.g., a height, a width, etc.) that exceed corresponding dimensions of the clip 22. The clip-securing piece 36 may be shorter than the base 30. The height differential between the base 30 and the clip-securing piece 36 may enable the base 30 to support the bent top 28 of the clip 22 from behind, while the bent top 28 emerges from and is located above a top edge of the clip-securing piece 36 and a remainder of the exterior portion 24 of the clip 22 extends downward from the bent top 28 and resides over the exterior of the clip-securing piece 36. The interior portion of the clip 22 resides, and is held in place, between the base 30 and the clip-securing piece 36. In a specific embodiment, a pair of rivets 40 may secure the interior portion of the clip 22 to the clip-securing piece 36. The sides and bottom of the clip-securing piece 36 may, in turn, be coupled (e.g., sewn, bonded, etc.) to the base 30, effectively securing the interior portion of the clip 22 in place between the clip-securing piece 36 and the base 30.

The base 30 and the clip-securing piece 36 may be formed from a variety of materials. Without limitation, the base 30 and the clip-securing piece 36 may be formed from nylon fabric. In some embodiments, the material from which the base 30 is formed may impart the attachment member 20 with sufficient rigidity to enable the attachment member 20 to support an accessory secured thereto, along with any item(s) held by the accessory.

In addition to the clip 22, the clip-securing piece 36 and the base 30, the attachment member 20 may include an accessory engagement element 38. The accessory engagement element 38 may be secured to or otherwise located on a front side 34 of the base 30. As shown, the back side 32 and the front side 34 of the base 30 are opposite from one another; thus, the clip 22 and the accessory engagement element 38 are located on opposite sides of the base 30. Thus, as shown in FIGS. 5-7, when the clip 22 is secured to a loop 16 on a panel 10 that covers an interior surface (e.g., a door, a wall, etc.) of a safe, the accessory engagement element 38 faces outward, away from the panel 10.

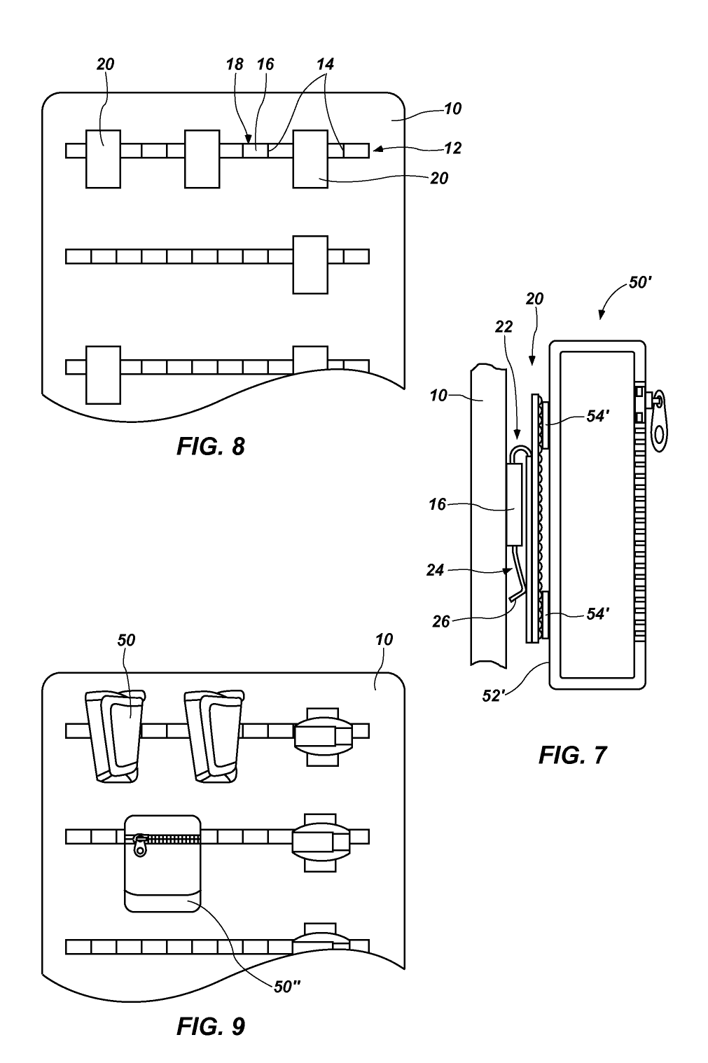

The accessory engagement element 38 may comprise any suitable means for engaging or being engaged by a corresponding feature of an accessory 50 (FIG. 6), 50′ (FIG. 7), etc., that is to be held in place on or over a panel 10 by the attachment member 20. Without limitation, the accessory engagement element 38 may comprise the “loop” side of a hook and loop fastener. Alternatively, the accessory engagement element 38 may comprise the hook side of a hook and loop fastener, an element of a hook-hook fastener, an element of a slidingly engageable fastener, an element of a snap fastener, or the like.

Of course, as shown in FIGS. 6 and 7, the accessory engagement element 38 of the attachment member 20 may be configured to engage a complementary attachment engagement element 54, 54′ on a back side 52, 52′ of an accessory 50, 50′. With continuing reference to FIGS. 6 and 7, an accessory 50, 50′ is secured to an attachment member 20, which is, in turn, secured to a panel 10 on an interior surface of a safe (e.g., by way of a loop 16, etc.). Accordingly, the attachment member 20, including its clip 22 (or other coupling element) and engagement element 38, are configured to mutually engage their complementary features (e.g., the loop 16 and the attachment engagement element 54, 54′, respectively) while supporting the weight of the accessory 50, 50′, as well as the weight of any other item(s) that may be carried by the accessory 50, 50′.

The accessory 50 depicted by FIG. 6 is a holder for a pistol. The attachment member 20 enables the accessory 50 and a pistol to be secured to a variety of different locations over panels 10 that cover interior surfaces, including an interior surface of a door, of a safe.

In FIG. 7, the accessory 50′ is a bag, or pouch, that may be configured to hold a variety of relatively small items. A few non-limiting examples of the types of items that may be held by the accessory 50′ are shotgun shells, bullets, firearm cleaning tools and the like. The attachment member 20 enables the accessory 50′ and its contents to be carried by a panel 10 and, thus, by an interior surface of a safe.

Referring now to FIGS. 8 and 9, a plurality of attachment members 20 may be secured to a panel 10 that covers an interior surface of a safe in a variety of different arrangements to secure a plurality of accessories 50, 50′, etc., to the panel 10. In some embodiments, two or more attachment members 20 may secure an accessory to the panel. The attachment members 20 may expand the functionality of an existing panel 10 by enabling a variety of different types of items to be secured to the panel 10 in a variety of different arrangements. Thus, the attachment members 20 may enable customization of an arrangement of accessories and items across an entire interior surface (e.g., an interior surface of a safe door, etc.) of a safe.

Although the foregoing disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

What is claimed:

1. An intermediate attachment member for use in securing an accessory to a surface within a safe, comprising:
a substantially flat body including a rear surface and a front surface;
a clip secured to the rear surface of the substantially flat body, the clip configured to engage a loop on a surface of a safe;
a substantially flat engagement material on the front surface of the substantially flat body, the substantially flat engagement material configured to mutually engage a complementary engagement material of an accessory to be secured in place relative to the surface of the safe.

2. The intermediate attachment member of claim 1, wherein the substantially flat engagement material comprises at least one of a hook material and a loop material.

3. The intermediate attachment member of claim 1, wherein the substantially flat engagement material is configured to support a combined weight of the accessory and at least a portion of an item to be held by the accessory.

4. The intermediate attachment member of claim 3, wherein the substantially flat engagement material is configured to support a combined weight of a pistol holder and a pistol.

5. The intermediate attachment member of claim 1, consisting essentially of the substantially flat body, the clip, the substantially flat engagement material and features and elements for securing the clip and the substantially flat engagement material to the substantially flat body.

6. A system for securing items within a safe, comprising:
a safe including a door with an interior surface, the interior surface of the door lacking a material that engages a hook material;
at least one loop carried by the interior surface of the door of the safe; and
at least one intermediate attachment member, including:
a substantially flat body with a rear surface and a front surface;
a clip secured to the rear surface of the substantially flat body, the clip configured to engage the at least one loop on the interior surface of the door of the safe;
a substantially flat engagement material on the front surface of the substantially flat body, the substantially flat engagement material configured to mutually engage a complementary engagement material of an accessory to be secured in place relative to the surface of the safe.

7. The system of claim 6, wherein the at least one loop is configured to support a combined weight of an intermediate attachment member, an accessory to be secured to the intermediate attachment member and at least a portion of an item to be held by the accessory.

8. The system of claim 7, wherein the substantially flat engagement element is configured to support a combined weight of the accessory and at least a portion of the item to be held by the accessory.

9. The system of claim 6, further comprising:
the accessory.

10. The system of claim 9, wherein the accessory comprises a pistol holder.

11. The system of claim 6, including a plurality of loops and a plurality of intermediate attachment members.

12. The system of claim 11, wherein at least two loops and at least two intermediate attachment members are arranged and configured to secure a single accessory to the interior surface of the door of the safe.

13. The system of claim 12, further comprising:
the single accessory.

14. The system of claim 13, wherein the single accessory comprises a bag.

15. A method for securing an accessory to an interior surface of a safe, comprising:
securing an intermediate attachment member to a loop on an interior surface of a safe; and
securing an accessory to the intermediate attachment member.

16. The method of claim 15, wherein securing the intermediate attachment member to the loop comprises clipping the intermediate attachment member to the loop.

17. The method of claim 15, wherein securing the accessory to the intermediate attachment member comprises causing complementary engagement materials of the accessory and the intermediate attachment member to mutually engage each other.

18. The method of claim 15, further comprising:
securing an item to be carried by the interior surface of the safe to the accessory.
